(19) United States
(12) Patent Application Publication
(10) Pub. No.: US 2013/0245159 A1
(43) Pub. Date: Sep. 19, 2013

(54) EPOXY RESIN COMPOSITION AND EPOXY POLYMER PRODUCED USING THE SAME

(71) Applicants: F. Brent Neal, Asheville, NC (US); Sharon A. Free, Rose Valley, PA (US); Keith A. Keller, Spartanburg, SC (US)

(72) Inventors: F. Brent Neal, Asheville, NC (US); Sharon A. Free, Rose Valley, PA (US); Keith A. Keller, Spartanburg, SC (US)

(21) Appl. No.: 13/611,973

(22) Filed: Sep. 12, 2012

Related U.S. Application Data
(60) Provisional application No. 61/535,923, filed on Sep. 16, 2011.

(51) Int. Cl. C08K 3/30; C08K 5/1515

(52) U.S. Cl. CPC C08K 3/30; C08K 5/1515
USPC 523/456

(57) ABSTRACT

An epoxy resin composition comprises an epoxy resin, a plurality of particles, and a diluent. The particles can comprise a magnesium oxysulfate compound. The diluent can be selected from the group consisting of monoglycidyl compounds, diglycidyl compounds, bisphenol-A alkoxylates, and mixtures thereof. The epoxy resin composition can be reacted with an activator composition to produce an epoxy polymer. The activator composition can comprise one or more compounds selected from the group consisting of polyamine compounds, anhydride compounds, and mixtures thereof.

### CROSS-REFERENCE TO RELATED APPLICATIONS

This application claims, pursuant to 35 U.S.C.§119(e), the benefit of the filing date of U.S. Patent Application No. 61/535,923, which was filed on Sep. 16, 2011.

### TECHNICAL FIELD

The invention relates to compositions suitable for use in producing polymer compositions, such as thermoset polymer compositions, and epoxy polymers produced using such compositions.

### BRIEF SUMMARY

As noted above, the invention relates to compositions suitable for use in producing polymer compositions, such as thermoset polymer compositions. For example, the invention provides compositions which are believed to be particularly well-suited for use in the production of epoxy polymers.

In one embodiment, the invention provides an epoxy resin composition comprising an epoxy resin, a plurality of particles, and a diluent. The particles can comprise a magnesium oxysulfate compound. The diluent can be selected from group consisting of monoglycidyl compounds, diglycidyl compounds, bisphenol-A alkoxylates, and mixtures thereof.

In another embodiment, the invention provides an epoxy polymer produced using the epoxy resin composition described above. In such an embodiment, the invention provides, for example, an epoxy polymer produced by reacting an epoxy resin composition and an activator composition. The epoxy resin composition can comprise an epoxy resin, a plurality of particles, and a diluent. The particles can comprise a magnesium oxysulfate compound. The diluent can be selected from group consisting of monoglycidyl compounds, diglycidyl compounds, bisphenol-A alkoxylates, and mixtures thereof. The activator composition can comprise one or more compounds selected from the group consisting of polyamine compounds, anhydride compounds, and mixtures thereof.

As noted above, the compositions (e.g., the epoxy resin compositions) described herein are believed to be well-suited for use in the production of epoxy polymers. While not wishing to be bound to any particular theory, it is believed that these compositions have proven to be useful due, at least in part, to the fact that the particles included in the epoxy resin composition are substantially “wetted out” and, therefore, become more fully incorporated into the matrix of an epoxy polymer produced using the epoxy resin composition. In other words, the “wetting out” of the particles substantially reduces the tendency of the particles to agglomerate and form “dry” regions in the epoxy polymer. These “dry” regions, which contain little of the epoxy polymer produced by the reaction of the epoxy resin and the activator composition, can be a source of weakness in the epoxy polymer, producing a polymer exhibiting an undesirable degree of brittleness and low toughness. Furthermore, it is also believed that the formulation of the epoxy resin compositions disclosed herein can be tailored to exhibit a range of viscosities, thereby allowing a high degree of flexibility in the production of the epoxy polymer, all while maintaining the compositions' desirable tendencies to “wet out” the particles and avoid the formation of “dry” regions in the epoxy polymer.

### DETAILED DESCRIPTION

In a first embodiment, the invention provides an epoxy resin composition. The epoxy resin composition comprises an epoxy resin, a plurality of particles, and a diluent.

The epoxy resin can be any suitable epoxy resin. Here, the term “epoxy resin” is used in its strict sense and refers to uncross-linked monomers or oligomers containing epoxy groups. Suitable epoxy resins include, but are not limited to, bisphenol-A diglycidyl ethers. Suitable bisphenol-A diglycidyl ethers include those having the following structure:

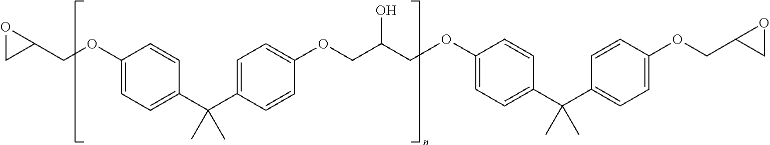

In this structure, n can be zero or any positive integer, but typically n is from 0 to about 25.

The epoxy resin can be present in the epoxy resin composition in any suitable amount. In a preferred embodiment, the epoxy resin is present in the epoxy resin composition in an amount of about 20 wt. % or more, based on the combined weight of the epoxy resin, the particles, and the diluent. (In other words, the epoxy resin accounts for about 20 wt. % or more of the combined weight of the epoxy resin, the particles, and the diluent.) In a more preferred embodiment, the epoxy resin is present in the epoxy resin composition in an amount of about 30 wt. % or more, about 40 wt. % or more, about 50 wt. % or more, or about 60 wt. % or more, based on the combined weight of the epoxy resin, the particles, and the diluent. In a preferred embodiment, the epoxy resin is present in the epoxy resin composition in an amount of about 80 wt. % or less, based on the combined weight of the epoxy resin, the particles, and the diluent. Thus, in certain preferred embodiments, the epoxy resin is present in the epoxy resin composition in an amount of about 20 wt. % to about 80 wt. %, about 30 wt. % to about 80 wt. %, about 40 wt. % to about 80 wt. %, about 50 wt. % to about 80 wt. %, or about 60 wt. % to about 80 wt. %, based on the combined weight of the epoxy resin, the particles, and the diluent.

The particles present in the epoxy resin composition can be any suitable particles. In a preferred embodiment, the particles comprise a magnesium oxysulfate compound. As utilized herein, the term “magnesium oxysulfate compound” refers to a compound comprised of magnesium hydroxide, magnesium sulfate, and waters of hydration. Thus, the magnesium oxysulfate compound can generally conform to the formula xMg(OH)₂.yMgSO₄.zH₂O, where x, y, and z are positive numbers greater than zero and ranging up to about 10. The values for x, y, and z include both integers and fractions due to the fact that the stoichiometry of the magnesium oxysulfate compound may result in, for example, magnesium hydroxide units that are “shared” by magnesium sulfate units and/or waters of hydration. In a preferred embodiment, the magnesium oxysulfate compound is selected from the group consisting of 5Mg(OH)₂.MgSO₄.3H₂O; 5Mg(OH)₂.MgSO₄.2H₂O; 3Mg(OH)₂.MgSO₄.8H₂O; Mg(OH)₂.MgSO₄.5H₂O; Mg(OH)₂.2MgSO₄.3H₂O; and mixtures thereof. Additional forms of magnesium oxysulfate are also believed to be suitable for use in the embodiments of the invention, such as 4.34Mg(OH)₂.MgSO₄.2H₂O and Mg(OH)₂.2MgSO₄.2H₂O.

The particles comprising the magnesium oxysulfate compound can be provided in any suitable form. For example, the particles can be provided in the form of spheres, plates, rods, or whiskers. The particles can have any suitable dimensions. However, the particles preferably are provided in a form in which the particles have, on average, one dimension (i.e., a length) that is substantially greater than the other two dimensions (i.e., width and height/thickness), such as plates, rods, or whiskers. Thus, in a preferred embodiment, the particles have an average aspect ratio of about 2 or more, about 3 or more, about 5 or more, or about 7 or more (e.g., about 10 or more or about 20 or more). As utilized herein, the term “aspect ratio” refers to the value obtained by dividing the length of a particle (i.e., the particle's largest dimension) by the arithmetic mean of the two remaining dimensions of the same particle (e.g., the width and height/thickness). The “average aspect ratio” is the arithmetic mean of the individual aspect ratios of the particles within a sample or collection or a statistically significant and representative random sample drawn from such a sample or collection. The aspect ratio and average aspect ratio of the particles can be determined by any suitable technique. For example, the two can be determined by measuring the dimensions of individual particles using, for example, a microscope (e.g., a scanning electron microscope) and then calculating the aspect ratio from the measured dimensions as described above.

As noted above, the particles can have any suitable dimensions. In a preferred embodiment, the particles have a length of about 1 μm or more, about 2 μm or more, about 3 μm or more, about 4 μm or more, or about 5 μm or more. In a preferred embodiment, the particles have a length of about 100 μm or less, about 90 μm or less, about 80 μm or less, about 70 μm or less, about 65 μm or less, or about 60 μm or less. Thus, in certain preferred embodiments, the particles have a length of about 1 μm to about 100 μm, about 2 μm to about 90 μm, about 3 μm to about 80 μm, about 4 μm to about 70 μm, or about 5 μm to about 65 μm (e.g., about 5 μm to about 60 μm). The two remaining dimensions of the particle (i.e., the width and height/thickness) can be of any suitable size. In a preferred embodiment, the particles have a width of about 0.1 μm or more, about 0.2 μm or more, about 0.3 μm or more, about 0.4 μm or more, or about 0.5 μm or more. Also, in a preferred embodiment, the particles have a width of about 10 μm or less, about 9 μm or less, about 8 μm or less, about 7 μm or less, about 6 μm or less, or about 5 μm or less. Thus, in certain preferred embodiments, the particles have a width of about 0.1 μm to about 10 μm, about 0.2 μm to about 9 μm, about 0.3 μm to about 8 μm, about 0.4 to about 7 μm, about 0.5 μm to about 6 μm (e.g., about 0.5 μm to about 5 μm).

The particles can be present in the epoxy resin composition in any suitable amount. In a preferred embodiment, the particles are preset in the epoxy resin composition in an amount of about 1 wt. % or more, based on the combined weight of the epoxy resin, the particles, and the diluent. In another preferred embodiment, the particles are present in the epoxy resin composition in an amount of about 2 wt. % or more, about 3 wt. % or more, about 4 wt. % or more, about 5 wt. % or more, about 6 wt. % or more, about 7 wt. % or more, about 8 wt. % or more, about 9 wt. % or more, or about 10 wt. % or more, based on the combined weight of the epoxy resin, the particles, and the diluent. In a preferred embodiment, the particles are present in the epoxy resin composition in an amount of about 30 wt. % or less or about 25 wt. % or less, based on the combined weight of the epoxy resin, the particles, and the diluent. Thus, in certain preferred embodiments, the particles are present in the epoxy resin composition in an amount of about 1 wt. % to about 30 wt. %, about 2 wt. % to about 30 wt. %, about 3 wt. % to about 30 wt. %, about 4 wt. % to about 30 wt. %, about 5 wt. % to about 30 wt. %, about 6 wt. % to about 30 wt. %, about 7 wt. % to about 30 wt. %, about 8 wt. % to about 30 wt. %, about 9 wt. % to about 30 wt. %, or about 10 wt. % to about 30 wt. %, based on the combined weight of the epoxy resin, the particles, and the diluent.

The diluent in the epoxy resin composition can be any suitable diluent. Preferably, the diluent contains at least one group that is capable of reacting with the activator composition, such as a glycidyl group or an alkoxy group. In a preferred embodiment, the diluent is selected from the group consisting of monoglycidyl compounds, diglycidyl compounds, bisphenol-A alkoxylates, and mixtures thereof. Monoglycidyl compounds suitable for use as the diluent include any suitable compound containing one glycidyl group. In a preferred embodiment, the epoxy resin composition comprises a diluent selected from the group consisting of alkyl monoglycidyl ethers, allyl monoglycidyl ethers, phenol monoglycidyl ethers, monoglycidyl esters, and mixtures thereof. In another preferred embodiment, the epoxy resin composition comprises a diluent selected from the group consisting of C₁₂-C₁₄ alkyl monoglycidyl ethers. Diglycidyl compounds suitable for use as the diluent include any suitable compound containing two glycidyl groups. In a preferred embodiment, the epoxy resin composition comprises a diluent selected from the group consisting of glycolic diglycidyl ethers. The term “glycolic diglycidyl ethers” is used herein to refer to diglycidyl ether compounds in which the “core” of the compound is derived from one or more diols or glycols. Suitable glycolic diglycidyl ethers include, but are not necessarily limited to, polyethylene glycol diglycidyl ethers, polypropylene diglycidyl ethers, ethylene oxide-propylene oxide copolymer diglycidyl ethers, neopentyl glycol diglycidyl ethers, 1,4-butanediol diglycidyl ether, 1,6-hexanediol diglycidyl ether, cyclohexanedimethanol diglycidyl ether, bisphenol-A alkoxylate diglycidyl ethers, and mixtures thereof. Bisphenol-A alkoxylates suitable for use in the epoxy resin composition include, but are not limited to, bisphenol-A ethoxylates. The diluent present in the composition is different than the epoxy resin. Thus, if the epoxy resin is a bisphenol-A diglycidyl ether, the diluent is a different diglycidyl compound, such as a different diglycidyl ether compound, a monoglycidyl compound, or a bisphenol-A alkoxylate.

The diluent can be present in the epoxy resin composition in any suitable amount. In a preferred embodiment, the diluent is present in the epoxy resin composition in an amount of about 0.1 wt. % or more, about 0.5 wt. % or more, or about 1 wt. % or more, based on the combined weight of the epoxy resin, the particles, and the diluent. In another preferred embodiment, the diluent is present in the epoxy resin composition in an amount of about 20 wt. % or less. Thus, in certain preferred embodiments, the diluent is present in the epoxy resin composition in an amount of about 0.1 wt. % to about 20 wt. %, about 0.5 wt. % to about 20 wt. %, or about 1 wt. % to about 20 wt. %, based on the combined weight of the epoxy resin, the particles, and the diluent.

In a second embodiment, the invention provides an epoxy polymer. The epoxy polymer is produced by reacting an epoxy resin composition according to the invention with an activator composition. The epoxy resin composition used to produce the epoxy polymer can be any of the epoxy resin compositions described above. Thus, the epoxy resin composition used to produce the epoxy polymer can contain any suitable combination of the epoxy resin(s), particles, and diluent(s) described above. In producing the epoxy polymer, the epoxy resin composition can be combined with additional epoxy resin prior to reaction with the activator composition, or the epoxy resin composition according to the invention can be used alone. When the epoxy resin composition according to the invention is combined with additional epoxy resin, the additional epoxy resin can be any suitable epoxy resin. For example, the additional epoxy resin can be the same as the epoxy resin included in the epoxy resin composition, or the epoxy resin can be different than the epoxy resin included in the epoxy resin composition. Of course, if additional epoxy resin is combined with the epoxy resin composition, one must ensure that the final amount of epoxy resin that is reacted with the activator composition is appropriate to yield an epoxy polymer exhibiting the desired properties.

The activator composition can be any suitable composition used to harden or cure an epoxy resin to produce an epoxy polymer. In a preferred embodiment, the activator composition comprises one or more compounds selected from the group consisting of polyamine compounds, anhydride compounds, and mixtures thereof. As utilized herein, the term “polyamine compound” refers to a compound containing two or more amine groups. In another preferred embodiment, the activator composition comprises a polyamine compound selected from the group consisting of aliphatic polyamines, cycloaliphatic polyamines, aromatic polyamines, and mixtures thereof. For example, suitable aliphatic polyamines include, but are not limited to, triethylenetetramine, tetraethylenepentamine, and mixtures thereof. Suitable aromatic polyamines include, but are not limited to, diethyl toluene diamine. Suitable examples of anhydride compounds include, but are not limited to, nadic methyl anhydride, phthalic anhydride, hexahydrophthalic anhydride, trimellitic anhydride, dodecenyl succinic anhydride, methyl hexahydrophthalic anhydride, tetrahydrophthalic anhydride, methyl tetrahydrophthalic anhydride, and mixtures thereof.

As noted above, it is believed that the epoxy polymer of the invention will exhibit a substantially lower amount of “dry” regions in the polymer matrix, as compared to other filled epoxy polymers produced using epoxy resin compositions that are different than the epoxy resin composition of the invention (i.e., “conventional” filled epoxy polymers). It is believed that this difference will result in a desirable increase in the toughness of the epoxy polymer and decrease in the brittleness, as compared to “conventional” filled epoxy polymers. The desirable increase in toughness and decrease in brittleness make the epoxy polymers according to the invention well-suited for applications or end-uses in which the epoxy polymer must exhibit relatively high degrees of toughness. For example, it is believed that the epoxy polymers according to the invention can be used in epoxy-based coatings (e.g., epoxy-based floor coatings), wind turbine blades, structural reinforcements, cowlings, marine applications (e.g., buoys and other surface and subsurface buoyancy devices, such as drill risers), adhesives, and other applications utilizing sheet and bulk molding compounds.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A epoxy resin composition comprising:
(a) an epoxy resin;
(b) a plurality of particles, the particles comprising a magnesium oxysulfate compound; and
(c) a diluent selected from the group consisting of monoglycidyl compounds, diglycidyl compounds, bisphenol-A alkoxylates, and mixtures thereof.

2. The epoxy resin composition of claim 1, wherein the epoxy resin is selected from the group consisting of bisphenol-A diglycidyl ethers.

3. The epoxy resin composition of claim 1, wherein the particles comprise a magnesium oxysulfate compound selected from the group consisting of 5Mg(OH)₂.MgSO₄.3H₂O; 5Mg(OH)₂.MgSO₄.2H₂O; 3Mg(OH)₂.MgSO₄.8H₂O; Mg(OH)₂.MgSO₄.5H₂O; Mg(OH)₂.2MgSO₄.3H₂O; and mixtures thereof.

4. The epoxy resin composition of claim 1, wherein at least a portion of the particles are in the form of whiskers, the whiskers having an average aspect ratio of about 7 or more.

5. The epoxy resin composition of claim 1, wherein the epoxy resin composition comprises a diluent selected from the group consisting of alkyl monoglycidyl ethers, allyl monoglycidyl ethers, phenol monoglycidyl ethers, monoglycidyl esters, and mixtures thereof.

6. The epoxy resin composition of claim 5, wherein the epoxy resin composition comprises a diluent selected from the group consisting of C₁₂-C₁₄ alkyl monoglycidyl ethers.

7. The epoxy resin composition of claim 1, wherein the epoxy resin composition comprises a diluent selected from the group consisting of glycolic diglycidyl ethers.

8. The epoxy resin composition of claim 7, wherein the glycolic diglycidyl ether is selected from the group consisting of polyethylene glycol diglycidyl ethers, polypropylene diglycidyl ethers, ethylene oxide-propylene oxide copolymer diglycidyl ethers, neopentyl glycol diglycidyl ethers, 1,4-butanediol diglycidyl ether, 1,6-hexanediol diglycidyl ether, cyclohexanedimethanol diglycidyl ether, bisphenol-A alkoxylate diglycidyl ethers, and mixtures thereof.

9. The epoxy resin composition of claim 1, wherein the epoxy resin composition comprises a diluent selected from the group consisting of bisphenol-A alkoxylates.

10. The epoxy resin composition of claim 9, wherein the epoxy resin composition comprises a diluent selected from the group consisting of bisphenol-A ethoxylates.

11. The epoxy resin composition of claim 1, wherein the epoxy resin is present in the epoxy resin composition in an amount of about 20 wt. % to about 80 wt. % based on the combined weight of the epoxy resin, the particles, and the diluent.

12. The epoxy resin composition of claim 1, wherein the particles are present in the epoxy resin composition in an amount of about 1 wt. % to about 30 wt. % based on the combined weight of the epoxy resin, the particles, and the diluent.

13. The epoxy resin composition of claim 1, wherein the diluent is present in the epoxy resin composition in an amount of about 0.1 wt. % to about 20 wt. % based on the combined weight of the epoxy resin, the particles, and the diluent.

14. An epoxy polymer produced by reacting:
(a) an epoxy resin composition comprising:
an epoxy resin;
(ii) a plurality of particles, the particles comprising a magnesium oxysulfate compound; and
(iii) a diluent selected from the group consisting of monoglycidyl compounds, diglycidyl compounds, bisphenol-A alkoxylates, and mixtures thereof; and
(b) an activator composition comprising one or more compounds selected from the group consisting of polyamine compounds, anhydride compounds, and mixtures thereof.

15. The epoxy polymer of claim 14, wherein the epoxy resin is selected from the group consisting of bisphenol-A diglycidyl ethers.

16. The epoxy polymer of claim 14, wherein the particles comprise a magnesium oxysulfate compound selected from the group consisting of 5Mg(OH)₂.MgSO₄.3H₂O; 5Mg(OH)₂.MgSO₄.2H₂O; 3Mg(OH)₂.MgSO₄.8H₂O; Mg(OH)₂.MgSO₄.5H₂O; Mg(OH)₂.2MgSO₄.3H₂O; and mixtures thereof.

17. The epoxy polymer of claim 14, wherein at least a portion of the particles are in the form of whiskers, the whiskers having an average aspect ratio of about 7 or more.

18. The epoxy polymer of claim 14, wherein the epoxy resin composition comprises a diluent selected from the group consisting of alkyl monoglycidyl ethers, allyl monoglycidyl ethers, phenol monoglycidyl ethers, monoglycidyl esters, and mixtures thereof.

19. The epoxy polymer of claim 18, wherein the epoxy resin composition comprises a diluent selected from the group consisting of C₁₂-C₁₄ alkyl monoglycidyl ethers.

20. The epoxy polymer of claim 14, wherein the epoxy resin composition comprises a diluent selected from the group consisting of glycolic diglycidyl ethers.

21. The epoxy polymer of claim 20, wherein the glycolic diglycidyl ether is selected from the group consisting of polyethylene glycol diglycidyl ethers, polypropylene diglycidyl ethers, ethylene oxide-propylene oxide copolymer diglycidyl ethers, neopentyl glycol diglycidyl ethers, 1,4-butanediol diglycidyl ether, 1,6-hexanediol diglycidyl ether, cyclohexanedimethanol diglycidyl ether, bisphenol-A alkoxylate diglycidyl ethers, and mixtures thereof.

22. The epoxy polymer of claim 14, wherein the epoxy resin composition comprises a diluent selected from the group consisting of bisphenol-A alkoxylates.

23. The epoxy polymer of claim 22, wherein the epoxy resin composition comprises a diluent selected from the group consisting of bisphenol-A ethoxylates.

24. The epoxy polymer of claim 14, wherein the epoxy resin is present in the epoxy resin composition in an amount of about 20 wt. % to about 80 wt. % based on the combined weight of the epoxy resin, the particles, and the diluent.

25. The epoxy polymer of claim 14, wherein the particles are present in the epoxy resin composition in an amount of about 1 wt. % to about 30 wt. % based on the combined weight of the epoxy resin, the particles, and the diluent.

26. The epoxy polymer of claim 14, wherein the diluent is present in the epoxy resin composition in an amount of about 0.1 wt. % to about 20 wt. % based on the combined weight of the epoxy resin, the particles, and the diluent.

27. The epoxy polymer of claim 14, wherein the activator composition comprises a polyamine compound selected from the group consisting of aliphatic polyamines, cycloaliphatic polyamines, aromatic polyamines, and mixtures thereof.

28. The epoxy polymer of claim 14, wherein the activator composition comprises an anhydride compound selected from the group consisting of nadic methyl anhydride, phthalic anhydride, hexahydrophthalic anhydride, trimellitic anhydride, dodecenyl succinic anhydride, methyl hexahydrophthalic anhydride, tetrahydrophthalic anhydride, methyl tetrahydrophthalic anhydride, and mixtures thereof.
